(19) United States
(12) Patent Application Publication
(10) Pub. No.: US 2015/0288245 A1
(43) Pub. Date: Oct. 8, 2015

(54) CONNECTION ELEMENT FOR A DRIVE ARRANGEMENT AND A DRIVE ARRANGEMENT HAVING A CONNECTION PART

(71) Applicant: Robert Bosch GmbH, Stuttgart (DE)

(72) Inventors: Jens Maerkle, Buehl (DE); Heiko Buss, Buehl (DE)

(21) Appl. No.: 14/436,106

(22) PCT Filed: Sep. 18, 2013
(86) PCT No.: PCT/EP2013/069409

§ 371 Date: Apr. 16, 2015

(30) Foreign Application Priority Data
Oct. 16, 2012 (DE) 10 2012 218 847.9

(51) Int. Cl. H02K 5/22; H02K 15/00; H02K 11/00

(52) U.S. Cl. CPC H02K 5/225; H02K 11/001; H02K 11/0021; H02K 15/00

(57) ABSTRACT

The invention relates to a connection element (5) for a drive arrangement (1) and to a method for producing same, in particular for an electric device for closing openings in a motor vehicle, comprising: a lead frame having a plurality of lead frame conductors (12); a sheath (7) for insulating the lead frame conductors (12), a section of the lead frame projecting at one end of the connection element (5) such that the lead frame conductors (12) are exposed; and one or a plurality of components (9), which are attached in an electrically conductive manner to the projecting section of the lead frame conductors (12), the components (9) being formed as SMD (surface mounted devices) parts.

### BACKGROUND OF THE INVENTION

The present invention relates to an electromotive drive arrangement, in particular for use in electric window actuators, and furthermore to the construction and the electrical contacting arrangement of drive arrangements. The invention relates in particular to the arrangement of electronic components between a supply line that contacts the drive arrangement and an electrical machine that is to be operated.

Closing systems, such as for example automatic window actuators, are conventionally operated with electrical drive arrangements, whose electrical drive can move a window pane to close and open a window. The drive arrangement is arranged for this purpose in a hollow space of a vehicle door, wherein the installation space that is available is extremely limited. Drive arrangements of this type are therefore provided with further components in a compact manner, that in order to achieve additional functions must be arranged near to the electrical drive of the drive arrangement in a space saving manner. Functions of this type can comprise by way of example electromagnetic interference suppression or a position detection of a rotor shaft of the drive.

In order to detect the position, magnetic field sensors such as by way of example Hall sensors are generally used in connection with an annular magnet that is arranged on the rotor shaft. The rate of movement can be calculated in an external control device from the position detection and it is possible to provide further functions such as, by way of example in the case of closing systems, a clamping protection.

The magnetic field sensors that are used to detect the position are generally assembled together with further electronic components on a circuit board in a pre-assembly step. The circuit board can then be connected to connecting lines in a connection element, in particular a plug housing, in an assembly step by means of soldering or pressfit technology and said connection element furthermore provides a plug interface to connecting lines, for example by way of a cable harness.

It is a complex procedure to populate the circuit board with the electronic components in a first pre-assembly stage and, in a subsequent assembly step, to solder the previously produced circuit board to a connection element or to press said circuit board into this connection element and finally to test the product.

The publication DE 44 04 986 A1 discloses a device for contacting electrical conductors for this purpose and said conductors are arranged on an insulating carrier. The electrical conductors are formed from a conductor rail structure that is embodied on the carrier in a one piece manner in that said electrical conductors are separated after they are applied to the carrier.

### SUMMARY OF THE INVENTION

The object of the present invention is to provide a connection element and a drive arrangement that can be produced in a simpler manner, in particular with a reduced number of production steps.

In accordance with a first aspect, a connection element for a drive arrangement, in particular for an electrical closing apparatus in a motor vehicle is provided, comprising:
a stamped lead frame having multiple stamped lead frame lines;
a casing in order to insulate the stamped lead frame lines, wherein a section of the stamped lead frame protrudes at an end of the connection element so that the stamped lead frame lines are exposed; and
one or multiple components that are attached to the protruding section of the stamped lead frame in an electrically conductive manner, wherein the components are embodied as SMD-components (surface mounted devices).

One idea of the above connection element is to directly contact the components that are hitherto arranged on the circuit board to the lines, in particular stamped lead frame lines of a stamped lead frame, in the connection element. As a consequence, it is possible to omit the installation of a circuit board and the production step of connecting the circuit board to the connection element. The line sections of the stamped lead frame that are to be provided with components are embodied for this purpose in a section as freely accessible for a process of fitting the components and the conducting elements are insulated by means of a casing with a housing part of the connection element.

Furthermore, a plug connector can be arranged on a further end of the connection element.

In particular, it is possible for the one or multiple components to comprise a capacitor and/or a coil and/or a magnetic field sensor.

A contact element for contacting the electrical drive can be arranged on the stamped lead frame.

At least one part of the stamped lead frame lines can be arranged in a plane.

In accordance with a further aspect, a drive arrangement is provided. The drive arrangement comprises:
a drive housing having an electrical drive; and
the above-mentioned connection element, wherein the end of the connection element projects into the drive housing in order to supply the electrical drive,

wherein a magnetic field sensor is electrically contacted as a component by means of the stamped lead frame lines, wherein the magnetic field sensor is positioned in the drive housing by means of the stamped lead frame in such manner that a magnetic field change as a result of the operation of the drive arrangement can be detected.

Furthermore, a magnetic field encoder can be connected to a rotor shaft of the electrical drive, wherein the magnetic field sensor can be arranged laterally with respect to the rotor shaft or on the front end face of the rotor shaft.

In accordance with a further aspect, a method for producing a connection element is provided, comprising the following steps:
producing a stamped lead frame having multiple stamped lead frame lines;
insulating the stamped lead frame lines so that a section of the stamped lead frame protrudes at an end of the connection element so that the stamped lead frame lines are exposed; and
attaching one or multiple components to the protruding section of the stamped lead frame lines in an electrically conductive manner.

Furthermore, the production of the stamped lead frame can involve providing initial injection procedures in order to fix the stamped lead frame lines with respect to one another.

It can also be provided that the stamped lead frame lines are insulated after attaching the one or multiple components.

In accordance with one embodiment, the electrically conductive attachment of the one or multiple components to the stamped lead frame lines can be performed by means of soldering or conductive adhesion. Since the conductive adhesion arrangement thermosets at comparatively low temperatures, the components—in particular SMD components—can also be connected to the conductor strips after the synthetic material injection molding process. The stamped lead frame lines can also be formed by means of multiple separate inserts. As a result of directly contacting the electrical components on the stamped lead frame lines, it is advantageously possible to omit additional circuit boards, by way of example sensor technology circuit boards.

### BRIEF DESCRIPTION OF THE DRAWINGS

Preferred embodiments of the present invention are further described hereinunder with reference to the attached drawings. In the drawings:

FIG. 1 illustrates a cross sectional illustration of a drive arrangement having an installed connection element;

FIG. 2 illustrates a side view of a connection element for a drive arrangement;

FIG. 3 illustrates a side view of a further connection element for a drive arrangement;

FIG. 4 illustrates a view of a stamped lead frame of the connection element of FIG. 2;

FIG. 5 illustrates a side view of a further embodiment of a connection element;

FIG. 6 illustrates a side view of a further embodiment of a connection element having an arrangement on a rotor shaft of the drive arrangement; and

FIG. 7 illustrates a flow diagram for illustrating a method for producing a connection element.

### DETAILED DESCRIPTION

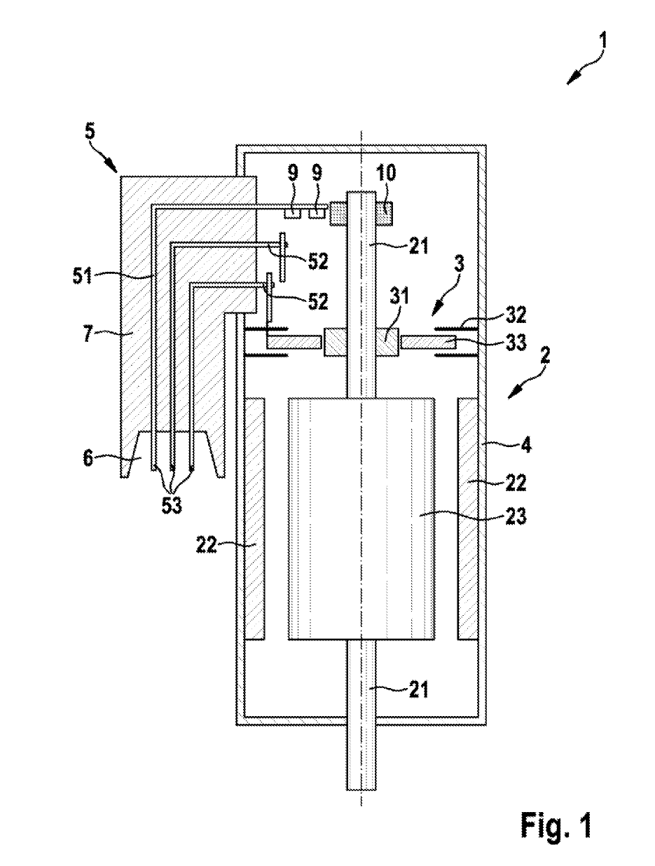

FIG. 1 illustrates a drive arrangement 1 having a housing 4 and a brush-commutated direct current motor 2 as a drive motor that is arranged in the drive housing 4.

The direct current motor 2 comprises stator magnets 22 that surround an inner recess in which is arranged a rotor 23 having rotor windings (not illustrated).

The rotor 23 is mounted on a rotor shaft 21 in the drive housing 4 in a rotatable manner. The direct current motor 2 comprises a commutator 3 that is arranged on the rotor shaft 21 and said commutator comprises a commutator ring 31 having commutator lamellae (not illustrated) and brushes 33 that are aligned to the commutator lamellae in brush holders 32. The brushes 33 are pre-stressed in the direction of the commutator lamellae and contact said commutator lamellae in an electrically conductive manner. The brushes 33 are electrically connected to brush contacts by way of brush wires (not illustrated).

The housing 4 comprises a recess through which during the assembly of the drive arrangement 1 a plug housing 5 is inserted as a connection element by means of which it is possible to contact the brush contacts in an electrical conductive manner.

The plug housing 5 provides a plug receiving arrangement 6 (plug connector) to receive a plug of a cable harness or the like and comprises furthermore electrical connecting lines 51 that lead from the plug receiving arrangement 6 through the plug housing 5 into the interior of the drive housing 4 of the drive arrangement 1. In lieu of the plug arrangement 6, it is possible to also provide another type of connecting device in order to provide an in particular detachable electrical connection to supply lines or rather a cable harness.

For this purpose, the plug housing 5 comprises a line casing 7 that extends from the plug housing receiving arrangement 6 to one end in the drive housing 4 of the drive arrangement 1 and provides at that location contact pins 52 or rather fork contacts or the like in order to electrically contact the brush contacts that are arranged at that location. The electrical connection can be produced by means of installing the plug housing 5 in the drive housing 4. Furthermore, at least one part of the connecting lines 51 is formed by means of a stamped lead frame that likewise protrudes from the end that is located in the drive housing 4. The connecting lines 51 that are embodied as a part of the stamped lead frame are described hereinunder as stamped lead frame lines 12.

The line casing 7 is embodied bent in an angled manner so that in the present exemplary embodiment contact pins 53 extend in the plug receiving arrangement 6 essentially parallel to the axis direction of the rotor shaft 21 of the drive 2. Alternatively, the line casing 7 can however also be embodied in a straight manner or in another shape.

At least the stamped lead frame lines 12 are preferably embodied in the plug housing 5 in the form of sheet metal strips that are pre-cut and fixed with respect to one another or similar, wherein the stamped lead frame lines 12 embody the contact pins 53 in the plug receiving arrangement 6 and extend to the housing interior of the drive housing 4 and at that location on the one hand, provide the contact arrangement for the brush contacts and furthermore a possibility for connecting electronic components 9.

The electronic components 9 that are to be arranged on the stamped lead frame lines 12 that are formed by means of the stamped lead frame can comprise by way of example suppressor components such as by way of example capacitors or coils, or sensor components such as by way of example a component for a magnetic field sensor. A Hall sensor, AMR sensor, GMR sensor can also be used as a magnetic field sensor. Other types of components that achieve a function regarding the drive arrangement 1 can also be arranged on the stamped lead frame lines 12 that extend into the drive housing 4. The components 9 are preferably embodied as SMD components (surface mounted devices) that by way of example are electrically connected on the stamped lead frame by means of conductive adhesion or SMD soldering.

The stamped lead frame lines 12 of the stamped lead frame preferably project so far into the drive housing 4 that the magnetic field sensor that is attached thereto can detect a magnetic field of the annular magnet 10 that is arranged on a section of the rotor shaft 21. The annular magnet 10 is positioned in the drive housing 4 in such a manner that in the case of installing the plug housing 5 in the drive housing 4, the component 9 that is embodied as a magnetic field sensor is arranged correspondingly near to the annular magnet 10.

The connection element that is embodied as a plug housing can also be embodied as a brush holder element in a further embodiment and the brushes 33 for contacting the collector 3 are received on said brush holder element. The brush holder element comprises a recess through which the rotor shaft 21 of the electrical drive engages.

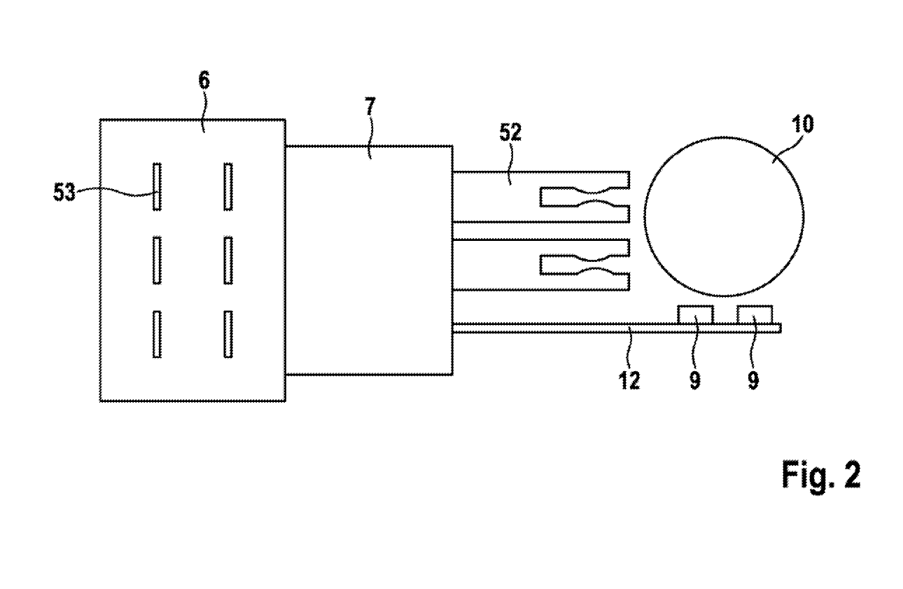

FIG. 2 illustrates a side view of the plug housing 5. The end of the plug housing 5 that is allocated to the interior of the housing of the drive housing 4 comprises contact pins 52 as contact elements for contacting the brush contacts and also the stamped lead frame lines 12. The stamped lead frame lines 12 that are illustrated in FIG. 2 only in a side view project beyond the contact pins 52 further into the housing interior and are suitably shaped and arranged next to one another so that individual electronic components 9 can be attached between the stamped lead frame lines 12, in particular SMD components. For this purpose, the stamped lead frame lines 12 can have a variable or rather varying width in order to adjust the spacing between adjacent stamped lead frame lines 12 to the length of the electronic component 9 that is to be connected between said stamped lead frame lines.

The components 9 are preferably embodied as SMD components and can be arranged by means of soldering or conductive adhesion using a suitable conductive adhesive between the stamped lead frame lines 12 so that the electronic function is ensured.

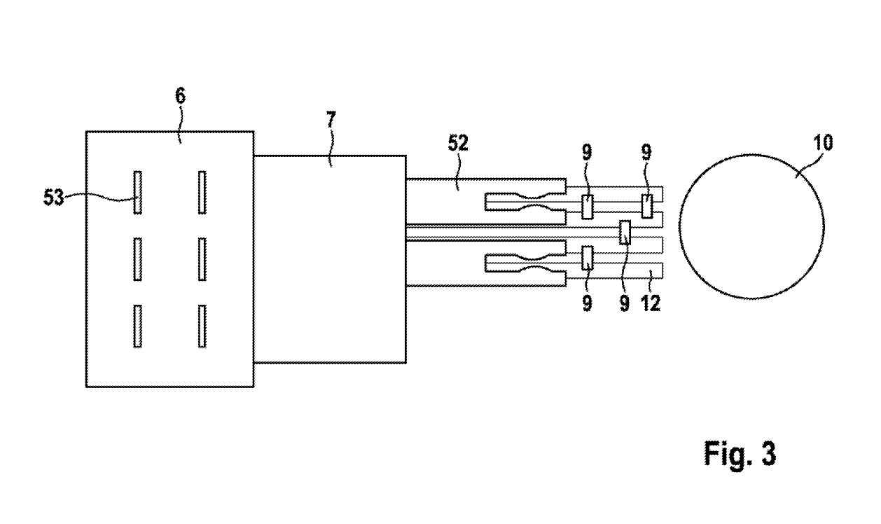

The stamped lead frame lines 12 are preferably arranged in a plane that, as is illustrated in FIG. 2, extends perpendicular to the plane in which the contact pins 52 (contact elements) are arranged or, as is illustrated in FIG. 3, extend parallel to the plane in which the commutator contacts 8 are arranged.

In particular, at least one upper surface of a stamped lead frame line 12 can be aligned to an upper surface of a further stamped lead frame line 12 in such a manner that this upper surface can lie at least in sections in a plane. The corresponding upper surfaces can then represent the contact surfaces for the connector of a component 9.

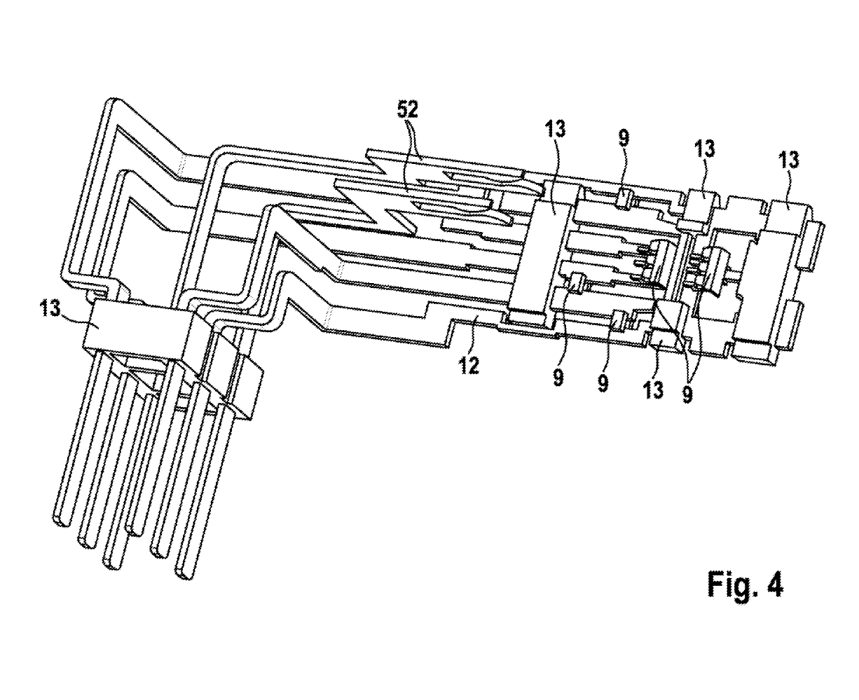

FIG. 4 illustrates the stamped lead frame without a line casing 7 and a plug receiving arrangement 6. The arrangement of the stamped lead frame lines 12 is evident and said stamped lead frame lines extend from the plug receiving arrangement 6 to the end that is to be arranged to the interior of the housing. Prior to attaching the line casing 7, the stamped lead frame lines 12 are fixed with respect to one another by means of providing one or multiple pre-injection molded parts 13. As a consequence, it is possible during the process of attaching the line casing 7 to ensure that the stamped lead frame lines 12 are not displaced with respect to one another since a predefined spacing between the stamped lead frame lines 12 is necessary to attach electronic components 9 of a specific size.

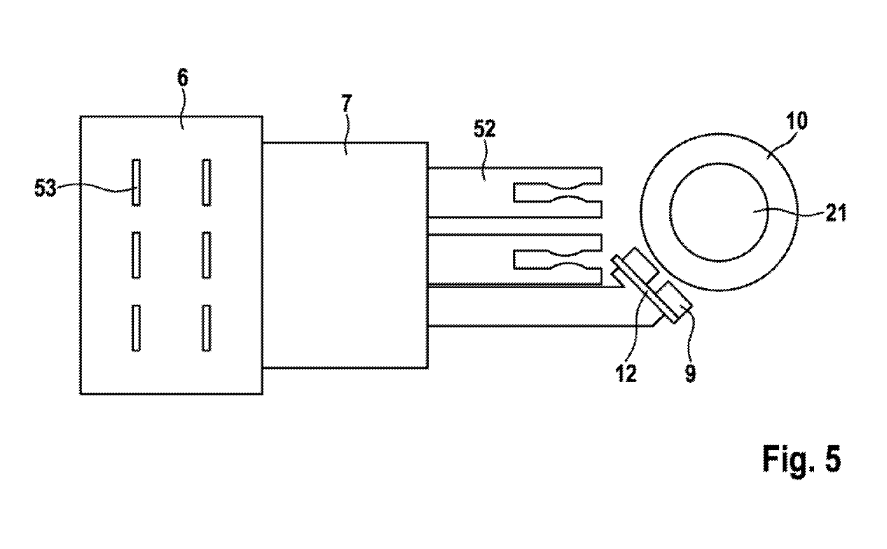

FIG. 5 illustrates a further arrangement of the stamped lead frame plane. At this location, the stamped lead frame lines 12 extend after exiting the end of the plug housing 5 that is facing the housing interior in a plane that is inclined with respect to the plane in which the commutator contacts are arranged and/or inclined with respect to the direction of exit of the stamped lead frame lines 12 from the respective end of the plug housing 5.

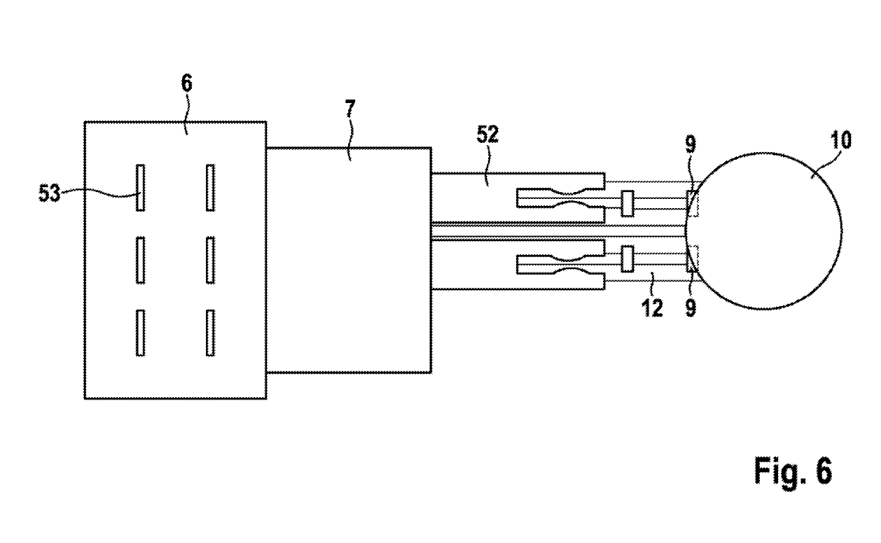

As is illustrated in the drive arrangement 1 of FIG. 6, the plane in which the stamped lead frame lines 12 extend when the plug housing 5 is plugged in, is arranged essentially perpendicular to the axial direction of the rotor shaft 21 so that in the case of the plug housing 5 being plugged in, the stamped lead frame lines 12 overlap the front end face of the end of the rotor shaft 21 that is provided with the annular magnet 10 in order to detect in this manner the change in the magnetic field at the side of the annular magnet 10, in particular axially lying opposite the annular magnet 10 on the rotor shaft 21.

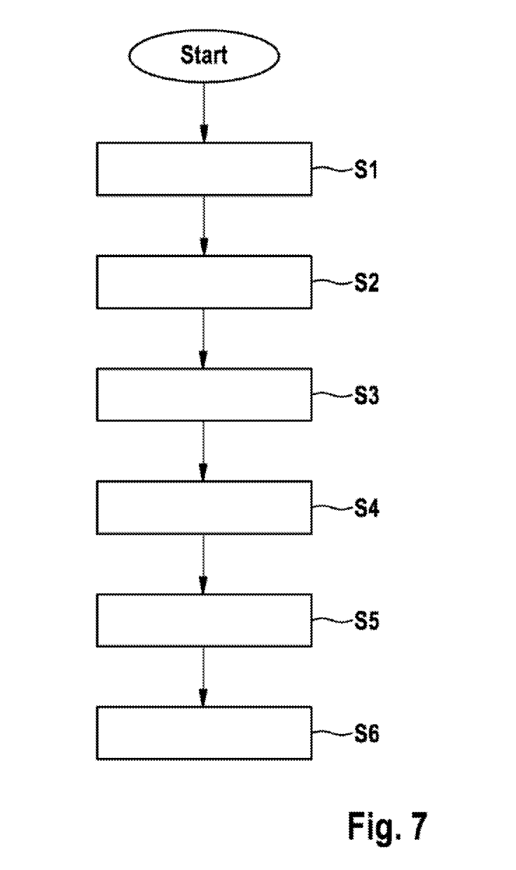

A method for producing a plug housing 5 for a drive arrangement 1, as is illustrated in FIG. 1, is further explained hereinunder with reference to the flow diagram in FIG. 7.

Initially in step S1, a metal sheet or a plate is stamped out from another conductive material in order to achieve the stamped lead frame lines 12. The stamped lead frame lines 12 that are stamped in this manner are arranged or rather aligned with respect to one another and are provided by means of an initial injection molding procedure (step S2) with pre-injection molded parts that can be arranged transversely with respect to the direction in which the stamped lead frame lines 12 extend so that the stamped lead frame lines 12 that are achieved as a result of the stamping process of the step Si are fixed with respect to one another and their arrangement is maintained.

Subsequently, the stamped lead frame lines 12 that are achieved in this manner and fixed with respect to one another are bent at an angle (step S3) and possible additional contacts, such as by way of example the commutator contacts 8 are connected in a suitable manner to the stamped lead frame (step S4).

Subsequently (step S5), a section of the stamped lead frame that is to be provided with a line casing 7 is injection molded so that the line casing 7 and the plug receiving arrangement 6 are embodied. A region of the stamped lead frame remains without a line casing 7 on an end of the plug housing 5 that lies opposite the plug receiving arrangement 6 and said region can be subsequently populated with electronic components 9 (step S6) in that said components are attached by means of soldering, welding or adhesion using a conductive adhesive.

By virtue of the above method, it is no longer necessary to populate a circuit board and connect it to the plug housing 5 by means of soldering or pressfit technology and the processes of assembly and connecting to the conductors of the plug housing 5 can be performed in an advantageous manner in one working step.

In lieu of a direct current motor, an electronically commutated electrical machine can also be provided as a drive motor.

1. A connection element (5) for a drive arrangement (1), comprising:
a stamped lead frame having multiple stamped lead frame lines (12);
a casing (7), in order to insulate the stamped lead frame lines (12), wherein a section of the stamped lead frame protrudes beyond the casing (7) at an end of the connection element (5) so that the stamped lead frame lines (12) are exposed; and
one or multiple components (9) that are attached in an electrically conductive manner to the protruding section of the stamped lead frame lines (12), wherein the components (9) are surface mounted devices.

2. The connection element (5) as claimed in claim 1, wherein a contact element (52) for the motor current of the drive arrangement is arranged on the stamped lead frame.

3. The connection element (5) as claimed in claim 1, wherein the one or multiple components (9) comprise at least one of a capacitor, a coil and a magnetic field sensor.

4. The connection element (5) as claimed in claim 1, wherein at least one part of the stamped lead frame lines (12) are embodied in a planar manner and lie in a common plane that forms a base surface for receiving the surface mounted devices.

5. The connection element (5) as claimed in claim 1, wherein one of the surface mounted devices is embodied as a separate Hall sensor that is connected directly to two stamped frame lines (12) in an electrically conductive manner.

6. The connection element (5) as claimed in claim 1, wherein the casing (7) is embodied as a component part of a brush holder component part, and the brush holder component part receives brushes (33) so as to contact a commutator (3).

7. A drive arrangement (1) comprising:
a drive housing (4) having an electrical drive; and
a connection element (5) as claimed in claim 1, wherein the connection element (5) is embodied as a plug module that can be produced separately, and the end of the connection element (5) projects after assembly into the drive housing (4) in order to supply the electrical drive,
wherein a magnetic field sensor is electrically contacted as a component (9) by means of the stamped lead frame lines (12) in order to detect a rotor position of the electrical drive, wherein a magnetic field encoder is connected to a rotor shaft (21) of the electrical drive, and the magnetic field sensor is positioned in the drive housing (4) by virtue of the stamped lead frame in such a manner that the magnetic field sensor is arranged radially and/or axially with respect to the magnetic field encoder.

8. A method for producing a connection element (5), comprising the following steps:
producing a stamped lead frame having multiple stamped lead frame lines (12);
insulating the stamped lead frame lines (12) so that a section of the stamped lead frame protrudes on one end of the connection element in such a manner that the stamped lead frame line ends (12) are exposed; and
attaching one or multiple components (9) in an electrically conductive manner to the section of the protruding stamped lead frame lines (12) that is protruding, wherein the components (9) are surface mounted devices.

9. The method as claimed in claim 8, wherein producing the stamped lead frame initially involves providing a synthetic material casing in order to fix and/or insulate the stamped lead frame lines (12) with respect to one another, and that subsequently one or multiple components (9) are fastened to the protruding section of the stamped lead frame lines (12) in an electrically conductive manner.

10. The method as claimed in claim 8, wherein insulating the stamped lead frame lines (12) is performed after attaching the one or multiple components (9).

11. The method as claimed in claim 8, wherein attaching the one or multiple components (9) to the stamped lead frame lines (12) in an electrically conductive manner is performed by means of surface mounted device soldering or conductive adhesion.

12. The connection element (5) as claimed in claim 1, wherein a contact element (52) for the motor current of the electrical drive is arranged on the stamped lead frame, and a plug connector (6) for receiving a plug is arranged on a further end of the connection element (5).

13. The connection element (5) as claimed in claim 1, wherein the one or multiple components (9) comprise a Hall sensor.

14. The connection element (5) as claimed in claim 1, wherein two or three stamped lead frame lines (12) are embodied in a planar manner and lie in a common plane that forms a base surface for receiving the SMD components, wherein this base surface is formed by means of the ends of the stamped lead frame lines (12) that are bent at an angle.

15. The connection element (5) as claimed in claim 1, wherein the casing (7) is embodied as a component part of a brush holder component part that is arranged between a pole housing and a transmission housing, and the brush holder component part receives brushes (33) so as to contact a commutator (3).

16. The method as claimed in claim 8, wherein insulating the stamped lead frame lines (12) includes injection molding.

17. The method as claimed in claim 16, wherein injection molding of the stamped lead frame lines (12) is performed after attaching the one or multiple components (9).
